(19) United States
(12) Patent Application Publication
(10) Pub. No.: US 2017/0274407 A1
(43) Pub. Date: Sep. 28, 2017

(54) Coating Apparatus

(71) Applicant: Dexerials Corporation, Tokyo (JP)

(72) Inventors: Atsushi UCHIDA, Tochigi-shi (JP); Yukio SUYAMA, Utsunomiya-shi (JP); Seiji GUNJI, Kaminokawa-machi (JP); Nobuyuki GOSHIMA, Tome-shi (JP)

(73) Assignee: Dexerials Corporation, Tokyo (JP)

(21) Appl. No.: 15/461,729

(22) Filed: Mar. 17, 2017

(30) Foreign Application Priority Data
Mar. 24, 2016 (JP) 2016-060621

(51) Int. Cl. B05C 5/00

(52) U.S. Cl. CPC B05C 5/005

(57) ABSTRACT

Provided is a coating apparatus that allows high-quality coating by causing a coated object to pass through a falling curtain of paint without vibrating the coated object. A coating apparatus 1, which coats a surface of a plate-shaped coated object M, includes: a table 10, on which the coated object M is disposed; a flow coater head 20, from which a curtain of paint P falls; a gutter-shaped liquid receiver 30, which is disposed below the flow coater head 20 and which collects the paint P falling from the flow coater head 20; and a horizontal conveying portion 41, which conveys the table 10, on which the coated object M is disposed, in a horizontal direction to pass through the paint P falling from the flow coater head 20.

### TECHNICAL FIELD

The present disclosure relates to a coating apparatus that coats a surface of a plate-shaped coated object, especially to a coating apparatus that coats a surface of a coated object with paint as the coated object passes through a falling curtain of paint.

### BACKGROUND

In a conventionally known coating apparatus that coats a surface of a plate-shaped coated object, such as a plastic tile (P tile), with paint, such as ultraviolet curing resin, the surface of the coated object may be evenly coated with paint by conveying the coated object at a constant velocity to pass through a curtain of paint falling (flowing down) from a flow coater head. The coating apparatus, which is also called flow coater, generally employs a pair of belt conveyers as a conveying device, by which the coated object is conveyed to pass through the falling curtain of paint.

For example, Patent Literatures 1 and 2 each disclose a coating apparatus including the pair of belt conveyors which has a synchronized conveying velocity and which is arranged side by side in series. Above a gap provided between the belt conveyors, a flow coater head is disposed to permit a curtain of paint to be fallen to the gap. By conveying the coated object by transferring it from one belt conveyor to the other belt conveyor in the horizontal direction, the coating apparatus causes the coated object to pass through the curtain of paint to evenly coat the surface of the coated object with paint.

### CITATION LIST

### Patent Literatures

### PTL 1: JP2005205313A

### PTL 2: JP2007117958A

### SUMMARY

However, in the aforementioned conventional coating apparatus, when the coated object is transferred from one belt conveyor to the other belt conveyor, vibration may occur in the coated object. The vibration leads to the problem of defective coating, such as uneven coating, of paint coated to the surface of the coated object.

The present disclosure has been conceived in view of the above problem, and the present disclosure is to provide a coating apparatus that allows high-quality coating by causing the coated object to pass through the falling curtain of paint without vibrating the coated object.

One of aspects of the present disclosure resides in a coating apparatus that coats a surface of a plate-shaped coated object. The coating apparatus includes: a table on which the coated object is disposed; a flow coater head from which a curtain of paint falls; a gutter-shaped liquid receiver that is disposed below the flow coater head and that collects the paint falling from the flow coater head; and a horizontal conveying portion that conveys the table, on which the coated object is disposed, in a horizontal direction to pass through the paint falling from the flow coater head.

In a preferred embodiment of the coating apparatus according to the present disclosure, the horizontal conveying portion is configured by a single axis actuator that is linearly and reciprocatably movable in the horizontal direction.

In another preferred embodiment of the coating apparatus according to the present disclosure, the horizontal conveying portion is driven by a linear servo motor, as a driving source, that is configured to control acceleration and deceleration of the table.

In yet another preferred embodiment of the coating apparatus according to the present disclosure, the table is provided with a chuck portion that holds the coated object.

In yet another preferred embodiment of the coating apparatus according to the present disclosure, the liquid receiver includes an upper liquid receiver and a lower liquid receiver disposed separately, the upper liquid receiver extending from one lateral side of a conveying path of the coated object to below the conveying path, and the lower liquid receiver extending from another lateral side of the conveying path to below the conveying path and having a tip portion disposed below a tip portion of the upper liquid receiver to be aligned with the tip portion of the upper liquid receiver at an interval. Furthermore, the horizontal conveying portion is disposed below the upper liquid receiver. Moreover, the table is connected to the horizontal conveying portion via a support portion configured to pass through between the tip portion of the upper liquid receiver and the tip portion of the lower liquid receiver during conveyance of the coated object.

In yet another preferred embodiment of the coating apparatus according to the present disclosure, the coating apparatus further includes: a vertical conveying portion that conveys the table in a vertical direction, wherein, after coating of the coated object is completed, the table is conveyed downward by the vertical conveying portion, subsequently conveyed in the horizontal direction along a return path located below the lower liquid receiver by the horizontal conveying portion, and further subsequently conveyed upward by the vertical conveying portion to return to an initial position.

In yet another preferred embodiment of the coating apparatus according to the present disclosure, the vertical conveying portion is configured by a single axis actuator that is linearly and reciprocatably movable in the vertical direction.

In yet another preferred embodiment of the coating apparatus according to the present disclosure, the liquid receiver includes a first upper liquid receiver, a second upper liquid receiver, and a lower liquid receiver that are disposed separately, the first upper liquid receiver extending from one lateral side of a conveying path of the coated object to below the conveying path, the second upper liquid receiver extending from another lateral side of the conveying path to below the conveying path and having a tip portion disposed at an interval from and opposed to a tip portion of the first upper liquid receiver in the horizontal direction, and the lower liquid receiver having one end side portion disposed below the tip portion of the first upper liquid receiver to be aligned with the tip portion of the first upper liquid receiver at an interval and having another end side portion disposed below the tip portion of the second upper liquid receiver to be aligned with the tip portion of the second upper liquid receiver at an interval. Furthermore, the horizontal conveying portion is disposed below the lower liquid receiver. Moreover, the table is connected to the horizontal conveying portion via a first support portion and a second support portion, the first support portion extending from one lateral portion of the table and being configured to pass through between the tip portion of the first upper liquid receiver and the one end side portion of the lower liquid receiver during conveyance of the coated object, and the second support portion extending from another lateral portion of the table and being configured to pass through between the tip portion of the second upper liquid receiver and the other end side portion of the lower liquid receiver during conveyance of the coated object.

In yet another preferred embodiment of the coating apparatus according to the present disclosure, the horizontal conveying portion causes the table to pass through the paint falling from the flow coater head while changing a conveying velocity.

The present disclosure provides a coating apparatus that allows high-quality coating by causing the coated object to pass through the falling curtain of paint without vibrating the coated object.

### BRIEF DESCRIPTION OF THE DRAWINGS

In the accompanying drawings:

FIG. 1 is a perspective view illustrating a coating apparatus according to one of embodiments of the present disclosure;

FIG. 2 is a plan view of a coating apparatus illustrated in FIG. 1;

FIG. 3 is a sectional view taken along a line A-A in FIG. 2;

FIG. 4 is a sectional view taken along a line B-B in FIG. 2;

FIGS. 5A to 5F schematically illustrate a procedure of coating a coated object;

FIG. 6A illustrates how paint is collected by an upper liquid receiver and a lower liquid receiver in a state illustrated in FIG. 5A, and FIG. 6B illustrates how paint is collected by the upper liquid receiver and the lower liquid receiver in a state illustrated in FIG. 5B;

FIG. 7A is a characteristic line diagram illustrating a relation between conveying velocity and position of a table in coating at a constant velocity, and FIG. 7B schematically illustrates a coated object coated according to the coating at the constant velocity;

FIG. 8A is a characteristic line diagram illustrating an example of a relation between conveying velocity and position of a table in coating in which a coating thickness is changed, and FIG. 8B schematically illustrates a coated object coated according to the coating in which the coating thickness is changed;

FIG. 9A is a characteristic line diagram illustrating another example of a relation between conveying velocity and position of a table in coating in which a coating thickness is changed, and FIG. 9B schematically illustrates a coated object coated according to the coating in which the coating thickness is changed;

FIG. 10 is a front view illustrating a configuration of a coating apparatus according to a modification of FIG. 1;

FIG. 11 is a plan view of a coating apparatus according to the modification illustrated in FIG. 10; and

FIG. 12 is a side view of a coating apparatus according to the modification illustrated in FIG. 10.

### DETAILED DESCRIPTION

The present disclosure will be described in more detail below by illustration with reference to the drawings.

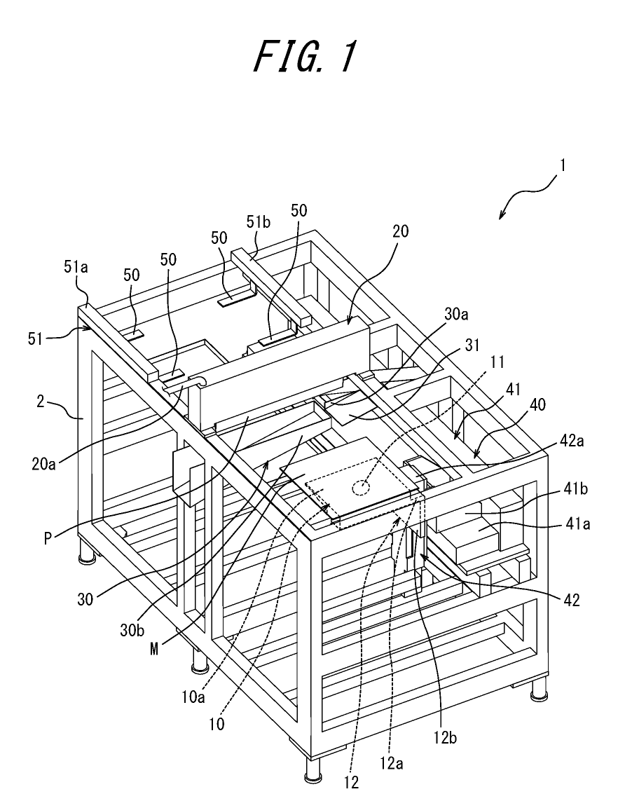

A coating apparatus 1 illustrated in FIGS. 1 to 4 according to one of embodiments of the present disclosure may also be called flow coater, and the coating apparatus 1 coats a surface of a plate-shaped coated object M by conveying the coated object M to pass through a falling curtain of paint P. In the present embodiment, a plastic tile (P tile) formed in a thin rectangular plate shape by a synthetic resin material is used as the coated object M. The present embodiment illustrates an example where the surface of the coated object M is coated with paint P, which is mainly composed of ultraviolet curing resin.

The coated object M, which has a plate shape, may be any plate-shaped object other than the aforementioned plastic tile. The paint P, which is used to coat the coated object M, may be anything other than the aforementioned paint composed mainly of ultraviolet curing resin.

In the illustrated example, the coating apparatus 1 includes a frame 2, which is configured by combining square pipes or the like, and the coating apparatus 1 is formed as a single unit including a table 10, a flow coater head 20, a liquid receiver 30, and a conveyor 40, which are assembled to the frame 2. Although not illustrated, a control panel, an operation panel, or the like used to control operation of the coating apparatus 1 may also assembled to the frame 2.

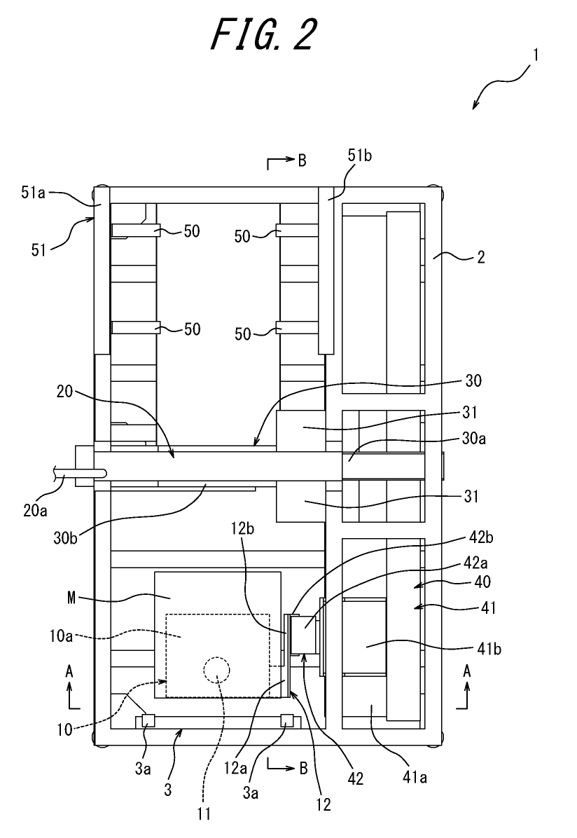

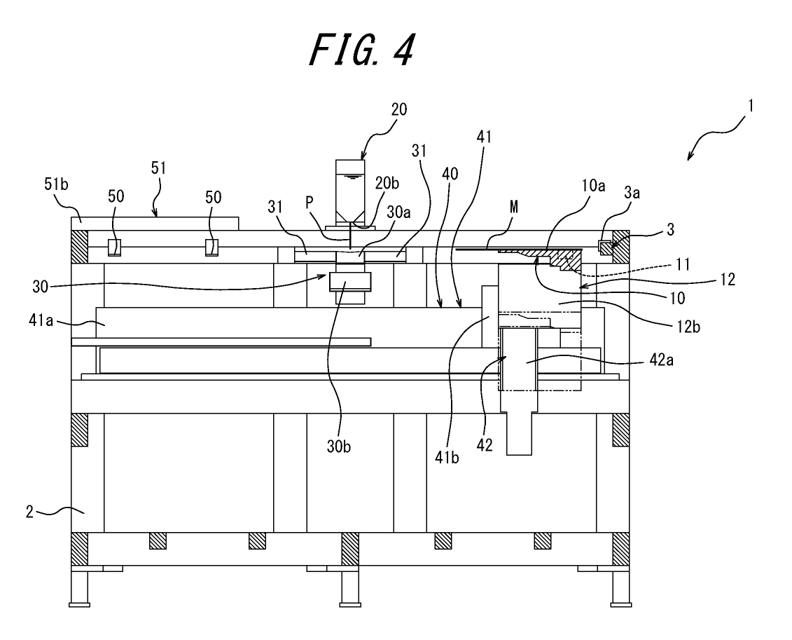

The table 10 has a rectangular external shape in a plan view, and the table 10 includes a flat upper surface 10a, on which the coated object M, as an object to be coated, may be disposed (mounted). As illustrated in FIG. 2, a lengthwise dimension and a widthwise direction of the upper surface 10a of the table 10 are smaller than a length of one side of the coated object M. When the coated object M is disposed in a predetermined position on the upper surface 10a of the table 10, the entire upper surface 10a of the table 10 is covered by the coated object M. As illustrated in FIG. 4, the table 10 is formed in a shape whose thickness is gradually reduced toward the front side in a conveying direction of the table 10.

As illustrated in FIG. 2, in one side portion of the frame 2, a positioning block 3 is fixed. The positioning block 3 includes a pair of convex portions 3a, which is arranged side by side at an interval corresponding to the length of one side of the coated object M. By disposing the coated object M on the table 10, with one side of the coated object M being in abutment with the positioning block 3 and with both lateral portions of the one side being fitted between the pair of convex portions 3a, in the state where the table 10 is in its initial position adjacent to the positioning block 3, the coated object M is easily positioned to the predetermined position in which the coated object M covers the entire upper surface 10a of the table 10.

As illustrated in FIG. 2, when the coated object M is positioned to the predetermined position on the upper surface 10a of the table 10, a front end portion of the coated object M that is located on the front side in the conveying direction protrudes further forward than a front end portion of the table 10, and both lateral portions of the coated object M protrude to the outer side of both lateral portions of the table 10.

In the present embodiment, the coated object M is disposed on the upper surface 10a of the table 10 manually by an operator. However, a conveying device, such as a robot arm, may also be used for automatic operation.

The table 10, on which the coated object M is disposed, is conveyed by the conveyor 40 in the horizontal direction from the one side portion of the frame 2 in which the positioning block 3 is fixed to the other side portion of the frame 2. Accordingly, the coated object M, together with the table 10, is moved along a conveying path, which is provided on both sides of the flow coater head 20 in the horizontal direction, to pass through a curtain of the paint P falling from the flow coater head 20. Thus, a surface of the coated object M that faces upward is coated.

Although not illustrated in detail, the table 10 may be provided, on the upper surface 10a, with a chuck portion 11. The chuck portion 11 may be configured by, for example, a vacuum suction chuck. In this case, a vacuum pump used to create a vacuum in the chuck portion 11 may be assembled to the frame 2. Providing the chuck portion 11 helps hold the coated object M to the table 10 firmly. This allows rapid acceleration and deceleration of the coated object M to a desired velocity during conveyance of the coated object M, together with the table 10, in the horizontal direction. Accordingly, flexibility in acceleration and deceleration operation of the table 10 is improved.

Additionally, the chuck portion 11 is not limited to the aforementioned vacuum suction chuck and may have any other configuration that permits the coated object M to be held to the table 10.

The flow coater head 20 is attached to the frame 2 in a middle position of the conveying path of the coated object M in a manner such that the flow coater head 20 is located above the conveying path. The flow coater head 20 is formed in a wide-width tank shape whose width is larger than one side of the coated object M, and the paint P is supplied into the flow coater head 20 through a supply pipe 20a. Although not illustrated in detail, the supply pipe 20a may be connected to, for example, a reservoir tank which stores the paint P to be supplied to the flow coater head 20 or to a supply pump used to supply the paint P stored in the reservoir tank toward the flow coater head 20.

As illustrated in FIG. 4, the flow coater head 20 is provided, on a lower surface thereof, with a slit 20b, through which the curtain of the paint P falls downward from the inside of the flow coater head 20. The width (width in a direction perpendicular to the conveying direction of the coated object M) of the slit 20b, that is to say, the width of the falling curtain of the paint P, may be set at will in accordance with the size and coating range of the coated object M. In the present embodiment, to coat the entire surface of the coated object M, the width of the slit 20b is set to be larger than the length of one side of the coated object M.

The curtain of the paint P falls in a manner such that the paint P is orthogonal to the conveying path of the coated object M to interrupt the conveying path. Accordingly, when the coated object M, conveyed along the conveying path by the table 10, passes through the falling curtain of the paint P, the entire surface of the coated object M is coated with the paint. At this time, as described earlier, since the front end portion of the coated object M that is located on the front side in the conveying direction protrudes further forward than the front end portion of the table 10 and since the thickness of the front side portion of the table 10 in the conveying direction is reduced, the paint P is surely prevented from being adhered to the front end portion of the table 10 even when the moving velocity of the table 10 passing through the falling curtain of the paint P is increased.

The liquid receiver 30 is formed in a gutter shape and disposed to be positioned right beneath the slit 20b below the flow coater head 20 to collect the paint P falling from the flow coater head 20. The paint P collected by the liquid receiver 30 is sent to the aforementioned reservoir tank and supplied toward the flow coater head 20 again by the supply pump. That is to say, a part of the paint P falling from the flow coater head 20 that is not coated to the surface of the coated object M is collected by the liquid receiver 30 and circulated between the flow coater head 20 and the reservoir tank. Additionally, a consumed amount of the paint P due to coating to the coated object M is supplemented to the reservoir tank as appropriate.

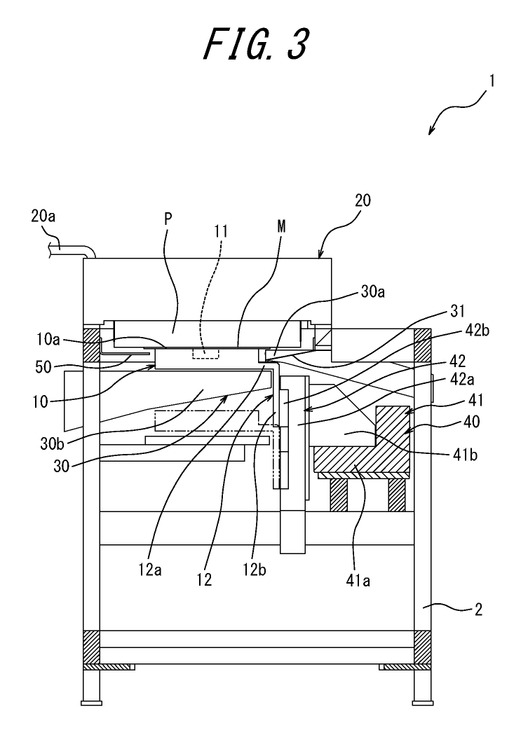

In the present embodiment, the liquid receiver 30 includes an upper liquid receiver 30a and a lower liquid receiver 30b disposed separately. The upper liquid receiver 30a is formed in a gutter shape having a substantially U-shaped section and also having a tip closed by a vertical wall. As illustrated in FIG. 3, the upper liquid receiver 30a extends from one lateral side (on the right side in FIG. 3) of the conveying path of the coated object M to below the conveying path, and a tip portion of the upper liquid receiver 30a is disposed adjacent to and close to the conveying path of the table 10. On the other hand, the lower liquid receiver 30b is formed in a gutter shape having a substantially U-shaped section and also having a tip closed by a vertical wall. The lower liquid receiver 30b extends from another lateral side (on the left side in FIG. 3) of the conveying path of the coated object M to below the conveying path. A tip portion of the lower liquid receiver 30b reaches to below the tip portion of the upper liquid receiver 30a, and the tip portion of the lower liquid receiver 30b is disposed to be aligned with the tip portion of the upper liquid receiver 30a at a predetermined interval in the vertical direction.

The upper liquid receiver 30a includes a bottom surface, which is formed as an inclined surface inclined downward as the bottom surface of the upper liquid receiver 30a extends to the lateral side away from the conveying path, and a lower end portion thereof is connected to the reservoir tank via, for example, a pipe, which is not illustrated. Similarly, the lower liquid receiver 30b includes a bottom surface, which is formed as an inclined surface inclined downward as the bottom surface of the lower liquid receiver 30b extends to the lateral side away from the conveying path, and a lower end portion thereof is connected to the reservoir tank via, for example, a pipe, which is not illustrated. Additionally, in the illustrated example, the bottom surface of the upper liquid receiver 30a is inclined at an angle of at least 10°, and the bottom surface of the lower liquid receiver 30b is inclined at an angle of at least 15°. However, the inclination angles may be changed in various ways.

With the above configuration, the curtain of the paint P falling from the flow coater head 20 is collected by the upper liquid receiver 30a and the lower liquid receiver 30b, and the collected paint is supplied to the reservoir tank to be supplied to the flow coater head 20 again.

On both sides of the tip portion of the upper liquid receiver 30a, there may also be disposed a pair of anti-scattering plates 31 to receive scattered paint. Furthermore, although not illustrated in detail, a receiving plate may be disposed below the conveying path of the coated object M to cover the entire lower side of the conveying path. The receiving plate may receive the paint dripped from the coated object M or the like. Moreover, to prevent scattering of the paint, an eaves-shaped protruding cover may be disposed on both sides or one side of a front surface and a rear surface of the flow coater head 20 along the conveying path.

In the present embodiment, the conveyor 40 includes a horizontal conveying portion 41 and a vertical conveying portion 42.

The horizontal conveying portion 41 serves to convey the table 10, on which the coated object M is disposed, in the horizontal direction along the conveying path to pass through the curtain of the paint P falling from the flow coater head 20. In the present embodiment, the horizontal conveying portion 41 is configured by a single axis actuator that is linearly and reciprocatably movable in the horizontal direction. In more detail, the horizontal conveying portion 41 includes a rail 41a, which is disposed below the upper liquid receiver 30a, and a slider 41b, which is linearly movable along the rail 41a. The rail 41a is formed in a linear shape with a length reaching from one side portion to another side portion of the frame 2, and the rail 41a is fixed to the frame 2, with the axis direction of the rail 41a being parallel with the conveying direction of the coated object M.

The horizontal conveying portion 41 is embedded with a linear servo motor (which is not illustrated) as a driving source thereof. The slider 41b is configured to be driven by the linear servo motor to be moved linearly and reciprocatably along the rail 41a. Operation of the linear servo motor is controlled by a control panel, which is not illustrated. The linear servo motor is capable of controlling acceleration and deceleration, so that the slider 41b, that is to say, the table 10, may be controlled to a desired moving velocity at a desired position.

The vertical conveying portion 42 serves to convey the table 10, on which the coated object M is disposed, in the vertical direction. In the present embodiment, the vertical conveying portion 42 is configured by a single axis actuator (single axis robot) that is linearly and reciprocatably movable in the vertical direction. In more detail, the vertical conveying portion 42 includes a linear-shaped rail 42a, which is fixed to the slider 41b with the axis direction of the rail 42a aligned with the vertical direction, and a slider 42b, which is linearly movable along the rail 42a. The slider 42b is configured to be driven by a driving source, such as a linear motor and an electric motor, embedded in the vertical conveying portion 42 to be moved linearly and reciprocatably along the rail 42a.

The table 10 is provided, on one lateral surface thereof, with a support portion 12 integrally. By the support portion 12 being fixed to the slider 42b of the vertical conveying portion 42, the table 10 is connected to the conveyor 40 via the support portion 12.

With the above configuration, the horizontal conveying portion 41 of the conveyor 40 conveys the table 10, on which the coated object M is disposed, horizontally along the conveying path to pass through the curtain of the paint P falling from the flow coater head 20. The vertical conveying portion 42 also conveys the table 10 downward when the table 10 reaches a terminal of the conveying path. Furthermore, the horizontal conveying portion 41 conveys the table 10, after it is conveyed downward by the vertical conveying portion 42, in the horizontal direction toward a direction opposite to the direction of movement in the conveying path along a return path, which is located below the conveying path and the lower liquid receiver 30b in parallel with the conveying path. Moreover, when the table 10 reaches a terminal of the return path, the vertical conveying portion 42 conveys the table 10 upward to return to its initial position. Thus, with the conveyor 40, which includes the horizontal conveying portion 41 and the vertical conveying portion 42, the table 10, on which the coated object M is disposed, is conveyed in the horizontal direction along the conveying path to pass through the curtain of the paint P falling from the flow coater head 20. Furthermore, once the coated object M after coating is removed from the table 10, the table 10 is moved downward and then returned to the initial position through the return path, which extends below the lower liquid receiver 30b. In this way, the table 10 is returned to the initial position without passing through the curtain of the paint P falling from the flow coater head 20.

The frame 2 is provided with four holding claws 50, which are used to hold the coated object M after coating. When the table 10 passes through the curtain of the paint P falling from the flow coater head 20, reaches the terminal of the conveying path, and subsequently is conveyed downward by the vertical conveying portion 42, four corners of the coated object M after coating are held by the four holding claws 50. The coated object M, held by the holding claws 50, may be removed from the coating apparatus 1 manually by an operator or by using a conveying device or the like.

On an upper surface of the frame 2, a photoelectronic safety device 51 may also be provided. The safety device 51 includes a light transmitter 51a and a light receiver 51b, which receives light emitted from the light transmitter 51a. The light transmitter 51a and the light receiver 51b are disposed to oppose each other, with a region in which the holding claws 50 are disposed therebetween. When light between the transmitter 51a and the light receiver 51b is blocked, the safety device 51 prohibits actuation of the horizontal conveying portion 41. Providing the safety device 51 improves safety of the coating apparatus 1 by preventing the horizontal conveying portion 41 from being activated erroneously in the state where a hand of an operator is inserted to the region in which the holding claws 50 are disposed.

The support portion 12, which is provided in the table 10, is formed in a bent plate shape in a reverse L-shape, including a flat plate-shaped extension portion 12a, which extends toward the lateral side from the lateral portion of the table 10, and a hanging portion 12b, which is connected to an end portion of the extension portion 12a integrally and which hangs downward. The support portion 12 is fixed to the slider 42b in the hanging portion 12b. The thickness of the extension portion 12a is smaller than a gap in the vertical direction between the tip portion of the upper liquid receiver 30a and the tip portion of the lower liquid receiver 30b. The extension portion 12a is configured to pass through the gap when the table 10 is conveyed in the horizontal direction along the conveying path. At this time, the support portion 12 passes below the upper liquid receiver 30a. Accordingly, adhesion of the paint to the support portion 12 is prevented when the table 10 is conveyed in the horizontal direction along the conveying path.

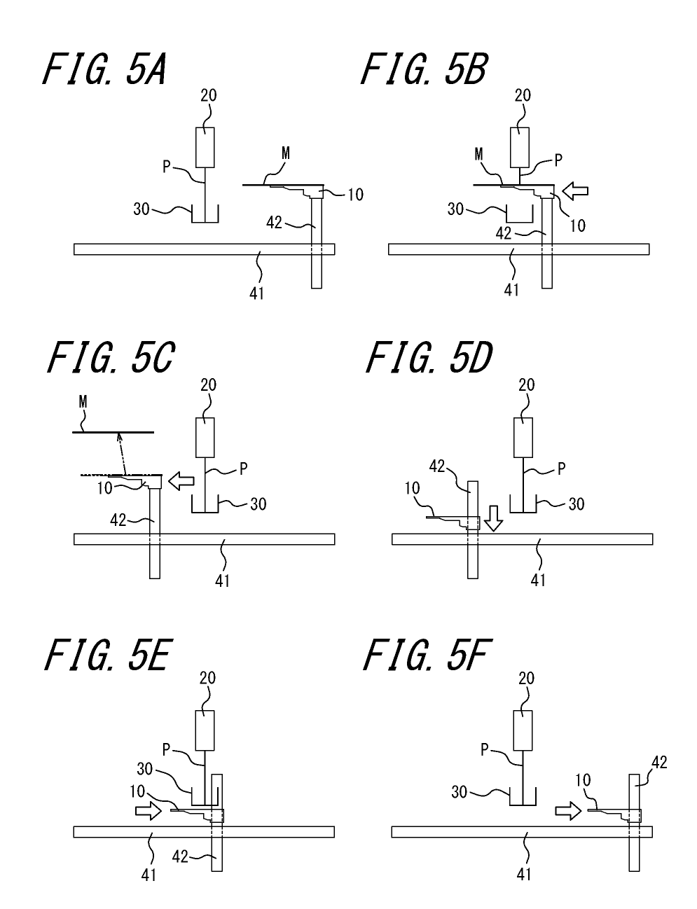

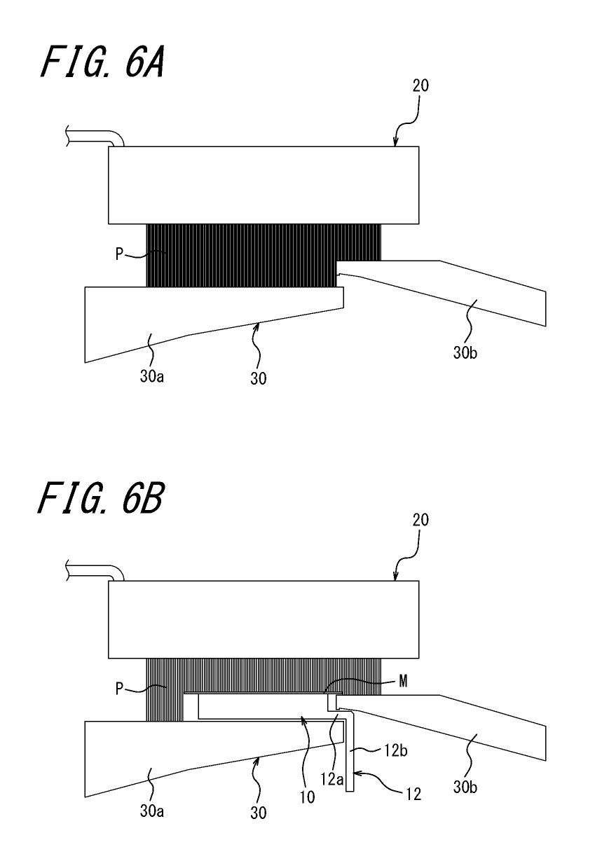

FIGS. 5A to 5F schematically illustrate a procedure of coating the coated object M. FIG. 6A illustrates how the paint is collected by the upper liquid receiver 30a and the lower liquid receiver 30b in the state illustrated in FIG. 5A, and FIG. 6B illustrates how the paint is collected by the upper liquid receiver 30a and the lower liquid receiver 30b in the state illustrated in FIG. 5B.

In the following, with reference to FIGS. 5A to 6B, a description is given of the procedure of coating the surface of the coated object M by using the coating apparatus 1.

Firstly, as illustrated in FIG. 5A, the coated object M is disposed on the table 10 in the initial position. At this time, as illustrated in FIG. 6A, the curtain of paint P falling from the flow coater head 20 is entirely received and collected by the upper liquid receiver 30a and the lower liquid receiver 30b. Accordingly, the paint P does not adhere to the conveyor 40, the frame 2, and so forth.

Secondly, in response to an activation operation to the operation panel, the horizontal conveying portion 41 starts operation. As illustrated in FIG. 5B, the table 10, on which the coated object M is disposed, is conveyed by the horizontal conveying portion 41 in the horizontal direction along the conveying path. Consequently, the coated object M passes through the curtain of the paint P falling from the flow coater head 20, and the surface of the coated object M is coated.

At this time, in the coating apparatus 1 of the present disclosure, the entire upper surface 10a of the table 10 is covered by the coated object M, which is disposed on the upper surface 10a. Moreover, the liquid receiver 30 includes the upper liquid receiver 30a and the lower liquid receiver 30b, and when the table 10, on which the coated object M is disposed, is conveyed in the horizontal direction to pass through the curtain of the paint P falling from the flow coater head 20, the support portion 12, which serves as a connecting portion between the table 10 and the conveyor 40, passes through the gap in the vertical direction between the tip portion of the upper liquid receiver 30a and the tip portion of the lower liquid receiver 30b. Accordingly, as illustrated in FIG. 6B, even though the coating apparatus 1 is configured to coat the coated object M by conveying the table 10, on which the coated object M is disposed, by the horizontal conveying portion 41 in the horizontal direction to pass through the curtain of the paint P falling from the flow coater head 20, the paint P does not adhere to the table 10, the support portion 12, and the conveyor 40.

When the table 10, on which the coated object M is disposed, reaches the terminal of the conveying path, the horizontal conveying portion 41 stops, and as illustrated in FIG. 5C, the coated object M after coating may be removed.

Subsequently, as illustrated in FIG. 5D, the vertical conveying portion 42 is activated, and the table 10 is conveyed downward. When the table 10 reaches a height corresponding to the return path, operation of the vertical conveying portion 42 is stopped.

Subsequently, as illustrated in FIG. 5E, the horizontal conveying portion 41 is operated toward the direction opposite to the direction of movement along the conveying path to convey the table 10 in the horizontal direction along the return path. Then, as illustrated in FIG. 5F, when the table 10 reaches the terminal of the return path, operation of the horizontal conveying portion 41 is stopped.

Subsequently, the vertical conveying portion 42 is activated, and the table 10 is conveyed upward to return to the initial position illustrated in FIG. 5A.

In a conventional coating apparatus employing a pair of belt conveyers, when the coated object is transferred from one belt conveyor to the other belt conveyor, vibration may occur, and this may lead to the problem of defective coating. In contrast, in the coating apparatus 1 according to the present disclosure, the table 10, on which the coated object M is disposed, is conveyed by the horizontal conveying portion 41 in the horizontal direction to pass through the curtain of the paint P falling from the flow coater head 20 for coating. Accordingly, the coating apparatus 1 causes the coated object M to pass through the falling curtain of the paint P without vibrating the coated object M. This allows high-quality coating of the surface of the coated object M. Furthermore, since the need for transferring the coated object M between the pair of belt conveyors is omitted, the coating apparatus 1 may coat the coated object M of a small size that is difficult to transfer by the pair of belt conveyors.

Moreover, with the chuck portion 11 provided in the table 10, flexibility in acceleration and deceleration of the table 10 is improved. Accordingly, even though the coated object M is disposed on the table 10 in the stopped state, the table 10 may be accelerated rapidly at a desired acceleration to a predetermined conveying velocity before the coated object M is conveyed to pass through the falling curtain of the paint P, and after the coating, the table 10 is rapidly decelerated toward the terminal of the conveying path to stop at a predetermined position. This allows downsizing of the device by reducing an acceleration distance necessary for acceleration and deceleration of the table 10 compared with cases employing the belt conveyors. Furthermore, since, even though the coated object M is disposed or removed while the table 10 is stopped, the coated object M is caused to pass through the falling curtain of the paint P after the table 10 is accelerated rapidly at the desired acceleration to the predetermined conveying velocity, safety of operation using the coating apparatus 1 is improved.

Especially when the single axis actuator driven by the linear servo motor as the driving source is adopted as the horizontal conveying portion 41, acceleration and deceleration of the table 10 is controlled even more precisely, and the aforementioned effect is even more enhanced.

Moreover, since flexibility in acceleration and deceleration of the table 10 is improved by the chuck portion 11 provided in the table 10, conditions of coating may be changed easily.

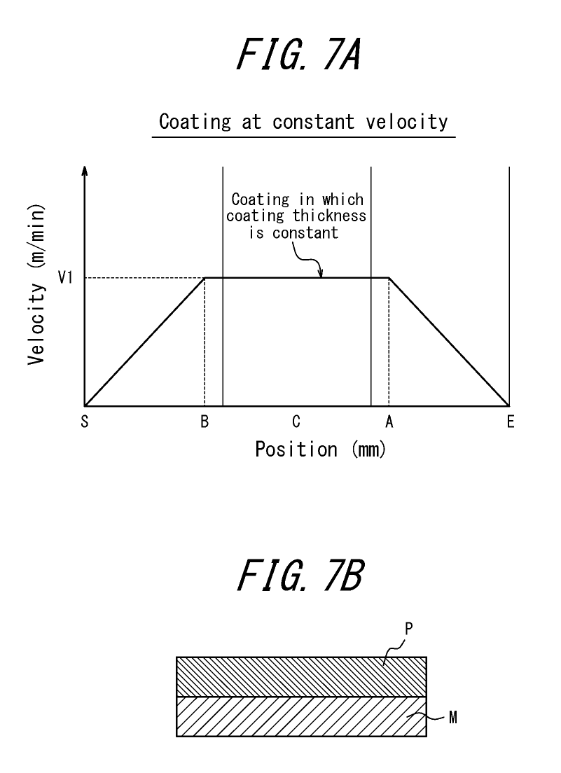

For example, in coating at a constant velocity, as illustrated in FIG. 7A, the table 10, on which the coated object M is disposed, may be accelerated at a predetermined acceleration from its initial position S to a position B, where the coated object M has not yet reached the falling curtain of the paint P. Subsequently, the table 10 may be caused to pass through a position C, underneath the falling curtain of the paint P, at a constant conveying velocity V1. From a position A, where the coated object M has passed through the paint P completely, to a position E, at the terminal of the conveying path, the table 10 may be decelerated at a predetermined acceleration to stop. By doing so, as illustrated in FIG. 7B, the surface of the coated object M may be coated evenly with a predetermined thickness of the paint P.

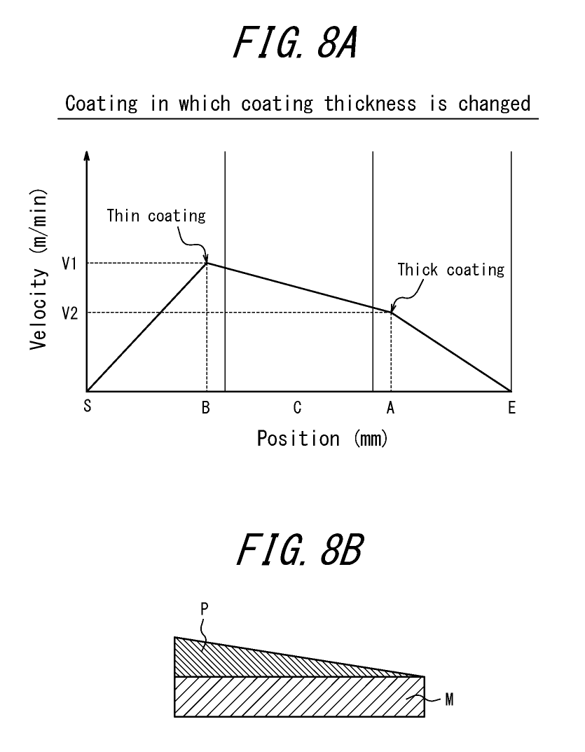

On the other hand, in coating in which the coating thickness is changed, as illustrated in FIG. 8A, the table 10, on which the coated object M is disposed, may be accelerated at a predetermined acceleration from its initial position S to the position B. Subsequently, from the position B to the position A, the conveying velocity may be decreased gradually from V1 to V2, while the table 10 passes through the position C. From the position A to the position E, the table 10 may be decelerated at a predetermined acceleration to stop. By doing so, as illustrated in FIG. 8B, the surface of the coated object M is coated with the paint P whose thickness is decreased gradually.

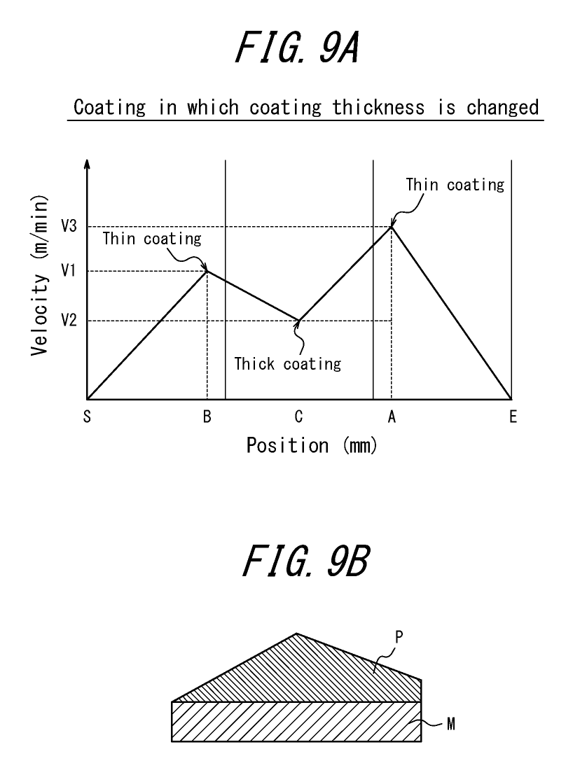

Additionally, in coating in which the coating thickness is changed, as illustrated in FIG. 9A, the table 10, on which the coated object M is disposed, may be conveyed by changing the conveying velocity in various patterns. For example, from the position B to the position C, the conveying velocity may be decreased gradually from V1 to V2, and subsequently, from the position C to the position A, the conveying velocity may be increased gradually from V2 to V3, which is faster than V1. Then, from the position A to the position E, the table 10 may be decelerated at a predetermined acceleration to stop. By doing so, as illustrated in FIG. 9B, the surface of the coated object M is coated with the paint P whose thickness is increased in a middle portion and decreased gradually on both sides of the middle portion at different ratios.

According to the aforementioned coating in which the coating thickness is changed by conveying the table 10 while changing the conveying velocity, conditions of coating may be changed easily (e.g., gradation coating may be applied) by changing the thickness of the paint P coated to the surface of the coated object M in different portions in the conveying direction.

In the above embodiment, the coating apparatus 1 includes the conveyor 40, which includes the horizontal conveying portion 41 and the vertical conveying portion 42. However, the present disclosure is not limited to the above embodiment, and the vertical conveying portion 42 may be omitted, and only the horizontal conveying portion 41 may be provided. In this case, the table 10 is moved by the horizontal conveying portion 41 reciprocatably between the initial position and the terminal of the conveying path. After the coated object M, after coating, is removed at the terminal of the forward path, the table 10, with a new uncoated coated object M being disposed thereon, is moved along the return path. Thus, the table 10 is moved reciprocatably without the paint P adhering to the table 10. In the above configuration, the coated objects M after coating are removed at both terminals of the conveying path. Accordingly, the safety device 51 is preferably provided on both sides of the flow coater head 20 of the frame 2.

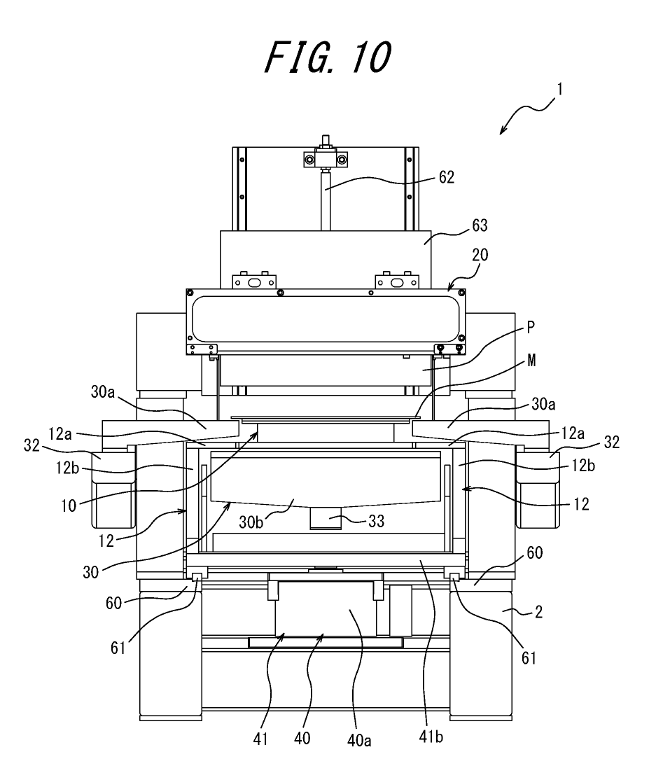

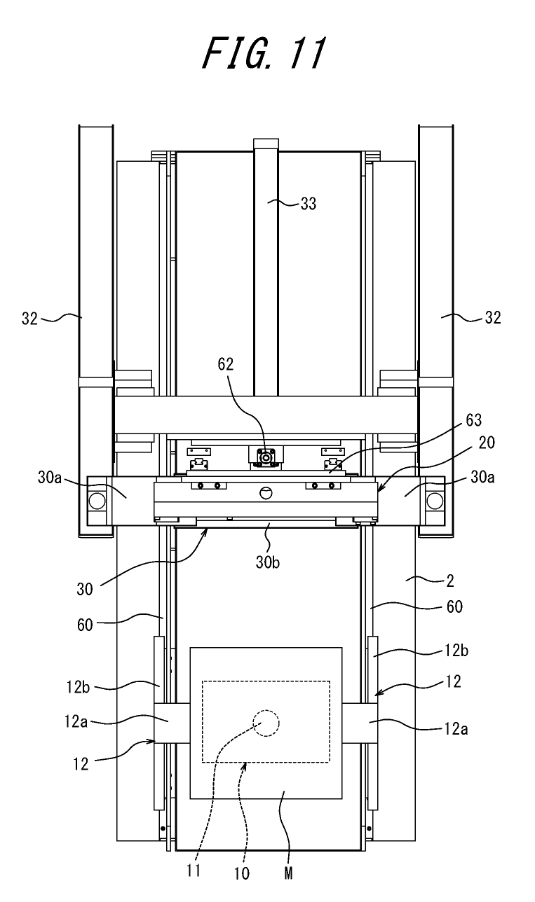

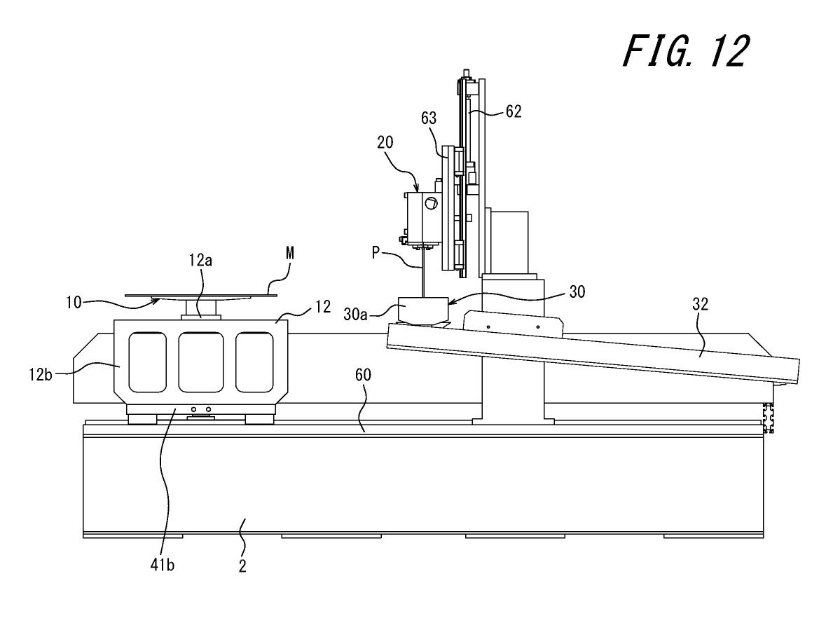

FIG. 10 is a front view illustrating the configuration of the coating apparatus 1 according to a modification of FIG. 1, and FIG. 11 is a plan view of the coating apparatus 1 according to the modification illustrated in FIG. 10, and FIG. 12 is a side view of the coating apparatus 1 according to the modification illustrated in FIG. 10. In FIGS. 10 to 12, members corresponding to those described above are denoted by the same reference numerals.

In the coating apparatus 1 illustrated in FIGS. 1 to 4, the table 10 is supported to the conveyor 40 by the support portion 12, which is provided on the one lateral portion of the table 10, in a cantilevered configuration. On the other hand, in the coating apparatus 1 illustrated in FIGS. 10 to 12, the support portion 12 is provided on both lateral portions of the table 10, and these support portions 12 support the table 10 to the conveyor 40 in a double-end supported configuration. In this case also, each support portion 12 is formed in a reverse L-shape including the flat plate-shaped extension portion 12a, which extends toward the lateral side from the corresponding lateral portion of the table 10, and the hanging portion 12b, which is formed in a flat plate shape having a width larger than the extension portion 12a and provided with three through holes and which is fixed to an end portion of the extension portion 12a to hang downward.

To prevent the paint P from adhering to the table 10 and the support portion 12 while supporting the table 10 to the conveyor 40 in the double-end supported configuration, the coating apparatus 1 in the present modification includes the liquid receiver 30, which includes three parts, that is to say, a pair of upper liquid receivers 30a and a single lower liquid receiver 30b, disposed separately. In more detail, one of the pair of upper liquid receivers (which may be called the first upper liquid receiver) 30a that is disposed on the right side in FIG. 10 is formed in a gutter shape having a substantially U-shaped section and also having a tip closed by a vertical wall. The first upper liquid receiver 30a extends from one lateral side (on the right side in FIG. 10) of the conveying path of the coated object M to below the conveying path, and a tip portion of the first upper liquid receiver 30a is disposed adjacent to and close to the conveying path of the table 10. Similarly, the other one of the pair of upper liquid receivers (which may be called the second upper liquid receiver) 30a that is disposed on the left side in FIG. 10 is formed in a gutter shape having a substantially U-shaped section and also having a tip closed by a vertical wall. The second upper liquid receiver 30a extends from the other lateral side (on the left side in FIG. 10) of the conveying path of the coated object M to below the conveying path. A tip portion of the second upper liquid receiver 30a is disposed at an interval from and opposed to a tip portion of the right-side upper liquid receiver 30a in the horizontal direction and also disposed adjacent to and close to the conveying path of the table 10. On the other hand, the lower liquid receiver 30b is formed in a gutter shape having a substantially U-shaped section and also having both ends closed by vertical walls. The lower liquid receiver 30b is disposed below the conveying path of the coated object M. One end side portion in the longitudinal direction of the lower liquid receiver 30b is disposed below the tip portion of the right-side upper liquid receiver 30a to be aligned with the tip portion of the right-side upper liquid receiver 30a at a predetermined interval in the vertical direction, and another end side portion in the longitudinal direction of the lower liquid receiver 30b is disposed below the tip portion of the left-side upper liquid receiver 30a to be aligned with the tip portion of the left-side upper liquid receiver 30a at a predetermined interval in the vertical direction.

Each of the pair of upper liquid receivers 30a includes a bottom surface, which is formed as an inclined surface inclined downward as the upper liquid receiver 30a extends to the lateral side away from the conveying path. To a lower end portion of each of the pair of upper liquid receivers 30a, a pipe 32, which is disposed along the frame 2, is connected, and the pair of upper liquid receivers 30a is connected to the receiver tank via the pipes 32. On the other hand, the bottom surface of the lower liquid receiver 30b is inclined in a V-shape in a manner such that a middle portion of the bottom surface in the width direction is lowest. To a portion of the lower liquid receiver 30b that is located below the lowest middle portion of the bottom surface, a pipe 33, which extends along the conveying path, is connected, and the lower liquid receiver 30b is connected to the reservoir tank via the pipe 33. With the above configuration, the curtain of the paint P falling from the flow coater head 20 is collected by the pair of upper liquid receivers 30a and the lower liquid receiver 30b, and the collected paint is supplied to the reservoir tank to be supplied to the flow coater head 20 again.

In the present embodiment, the conveyor 40 includes only the horizontal conveying portion 41, and the vertical conveying portion 42 is omitted. Furthermore, the horizontal conveying portion 41 is disposed below the lower liquid receiver 30b. On both lateral portions of the slider 41b of the horizontal conveying portion 41, a wheel 61, which is moved along a guide rail 60 provided in the frame 2, is disposed. This allows the slider 41b to move the table 10 with the double-end supported configuration stably.

Furthermore, in the present modification also, the thickness of the extension portion 12a in each of the pair of support portions 12 of the table 10 is smaller than the gap in the vertical direction between the tip portion of the corresponding upper liquid receiver 30a and the tip portion of the lower liquid receiver 30b. The extension portion 12a may pass through the gap when the table 10 is conveyed in the horizontal direction along the conveying path. At this time, each support portion 12 passes below the corresponding upper liquid receiver 30a. Accordingly, adhesion of the paint to the support portion 12 is prevented when the table 10 is conveyed in the horizontal direction along the conveying path.

In the coating apparatus 1 with the above configuration, since the table 10 is supported to the slider 41b of the horizontal conveying portion 41 in the double-end supported configuration, the table 10 is conveyed even more stably. Accordingly, the coated object M passes through the falling curtain of the paint P with less vibration, and quality of coating is further improved.

The flow coater head 20 is attached detachably to a support plate 63, whose position in the vertical position may be changed by a cylinder device 62. Accordingly, in stead of the flow coater head 20, other coaters, such as a die coater and a roller coater, may be attached to the support plate 63, and the coated object M, which is conveyed with the table 10, may be coated by the other coaters. At this time, by adjusting the height of the support plate 63, the variety of coaters may be positioned in accordance with the height of the conveyed coated object M. Furthermore, the table 10 is supported to the slider 41b firmly in the double-end supported configuration. Accordingly, even when, for example, the die coater, which is configured to press a die, provided with a slit through which the paint P is discharged, to the surface of the coated object M directly, or the roller coater, which is configured to press a roller, coated with the paint P, to the surface of the coated object M directly is employed as the coater, the table 10 is supported reliably without tilting or the like, and quality of coating of the coated object M is ensured.

Needless to say, the present disclosure is not limited to the above embodiment, and various changes may be made without departing the gist of the present disclosure.

For example, although in the above embodiment the horizontal conveying portion 41 is configured by the single axis actuator, the present disclosure is not limited to the above embodiment. Any other configuration, which allows the table 10, on which the coated object M is disposed, to be conveyed in the horizontal direction to pass through the curtain of the paint falling from the flow coater head 20, may be adopted. Furthermore, the driving source of the horizontal conveying portion 41 is not limited to the aforementioned linear servo motor. Any other system, such as an electric motor, which is configured to drive the slider 41b to move linearly and reciprocatably, may be used.

Similarly, the vertical conveying portion 42 is not limited to the aforementioned single axis actuator, and any other configuration, which allows the table 10 to be conveyed in the vertical direction, may be adopted. Moreover, as the driving source of the vertical conveying portion 42, a variety of systems, such as the linear servo motor and the electric motor adopted for the horizontal conveying portion 41, may be used.

Although in the above embodiment the support portion 12 is formed in the reverse L-shape extending from the lateral portion of the table 10, the present disclosure is not limited to the above embodiment. The support portion 12 only has to be configured to pass through the gap between the upper liquid receiver 30a and the lower liquid receiver 30b, and the shape and the extension position from the table 10 may be changed in various ways. In this case, the position of the gap in the vertical direction between the tip portion of the upper liquid receiver 30a and the tip portion or the end portion of the lower liquid receiver 30b may be changed to any of various positions, which are located below the conveying path of the coated object M.

Moreover, when paint mainly composed of ultraviolet curing resin is used as the paint P, a stage, on which the coated object M after coating may be disposed, may be provided in a position adjacent to the region of the frame 2 in which the holding claws 50 are disposed. An ultraviolet ray emission device may also be disposed above the stage. With the above configuration, by removing the coated object M after coating from the table 10 and placing it on the stage, the paint P coated to the surface of the coated object M may be cured before the coated object M is conveyed to the subsequent step.

1. A coating apparatus that coats a surface of a plate-shaped coated object, the coating apparatus comprising:
a table on which the coated object is disposed;
a flow coater head from which a curtain of paint falls;
a gutter-shaped liquid receiver that is disposed below the flow coater head and that collects the paint falling from the flow coater head; and
a horizontal conveying portion that conveys the table, on which the coated object is disposed, in a horizontal direction to pass through the paint falling from the flow coater head.

2. The coating apparatus of claim 1, wherein the horizontal conveying portion is configured by a single axis actuator that is linearly and reciprocatably movable in the horizontal direction.

3. The coating apparatus of claim 2, wherein the horizontal conveying portion is driven by a linear servo motor, as a driving source, that is configured to control acceleration and deceleration of the table.

4. The coating apparatus of claim 1, wherein the table is provided with a chuck portion that holds the coated object.

5. The coating apparatus of claim 1, wherein
the liquid receiver includes an upper liquid receiver and a lower liquid receiver disposed separately, the upper liquid receiver extending from one lateral side of a conveying path of the coated object to below the conveying path, and the lower liquid receiver extending from another lateral side of the conveying path to below the conveying path and having a tip portion disposed below a tip portion of the upper liquid receiver to be aligned with the tip portion of the upper liquid receiver at an interval,
the horizontal conveying portion is disposed below the upper liquid receiver, and
the table is connected to the horizontal conveying portion via a support portion configured to pass through between the tip portion of the upper liquid receiver and the tip portion of the lower liquid receiver during conveyance of the coated object.

6. The coating apparatus of claim 5, further comprising:
a vertical conveying portion that conveys the table in a vertical direction, wherein,
after coating of the coated object is completed, the table is conveyed downward by the vertical conveying portion, subsequently conveyed in the horizontal direction along a return path located below the lower liquid receiver by the horizontal conveying portion, and further subsequently conveyed upward by the vertical conveying portion to return to an initial position.

7. The coating apparatus of claim 6, wherein the vertical conveying portion is configured by a single axis actuator that is linearly and reciprocatably movable in the vertical direction.

8. The coating apparatus of claim 1, wherein
the liquid receiver includes a first upper liquid receiver, a second upper liquid receiver, and a lower liquid receiver that are disposed separately, the first upper liquid receiver extending from one lateral side of a conveying path of the coated object to below the conveying path, the second upper liquid receiver extending from another lateral side of the conveying path to below the conveying path and having a tip portion disposed at an interval from and opposed to a tip portion of the first upper liquid receiver in the horizontal direction, and the lower liquid receiver having one end side portion disposed below the tip portion of the first upper liquid receiver to be aligned with the tip portion of the first upper liquid receiver at an interval and having another end side portion disposed below the tip portion of the second upper liquid receiver to be aligned with the tip portion of the second upper liquid receiver at an interval,
the horizontal conveying portion is disposed below the lower liquid receiver, and
the table is connected to the horizontal conveying portion via a first support portion and a second support portion, the first support portion extending from one lateral portion of the table and being configured to pass through between the tip portion of the first upper liquid receiver and the one end side portion of the lower liquid receiver during conveyance of the coated object, and the second support portion extending from another lateral portion of the table and being configured to pass through between the tip portion of the second upper liquid receiver and the other end side portion of the lower liquid receiver during conveyance of the coated object.

9. The coating apparatus of claim 1, wherein the horizontal conveying portion causes the table to pass through the paint falling from the flow coater head while changing a conveying velocity.
